(19) United States
(12) Patent Application Publication
(10) Pub. No.: US 2005/0119430 A1
(43) Pub. Date: Jun. 2, 2005

(54) Process for preparing a water- and oil-repellent agent of aqueous dispersion type

(75) Inventors: Shean-Jeng Jong, Tao-Yuan (TW); Hong-Yue Hsu, Taipei (TW)

Correspondence Address: BACON & THOMAS, PLLC, 625 SLATERS LANE, FOURTH FLOOR, ALEXANDRIA, VA, 22314, US

(73) Assignee: Chung-Shan Institute of Science & Technology, Tao-Yuan (TW)

(21) Appl. No.: 10/724,822

(22) Filed: Dec. 2, 2003

(51) Int. Cl. C08F 2/00

(52) U.S. Cl. 526/217; 526/227; 526/303.1; 526/319

(57) ABSTRACT

The present invention discloses a process for preparing a water- and oil-repellent agent for textile including conducting a polymerization in a mixture of perfluoroalkyl(meth)acrylate (mixture)/alkyl(meth)acrylate/hydroxyalkyl(meth)acrylate/polyoxyalkylene glycol mono(meth)acrylate/non-ionic surfactant/ionic surfactant/vinyl monomer/chain transfer agent/water/organic dissolution agent/free radical initiator under stirring to form an emulsion containing a copolymer particles having an average particle size of about 100 nm, which can be diluted with water as desired to form a water- and oil-repellent agent aqueous dispersion. The process of the present invention does not require a high pressure homogenizer or a special emulsifying equipment.

### FIELD OF THE INVENTION

The present invention relates to a method for preparing a water- and oil-repellent agent for textile, particularly a method for preparing a copolymer emulsion as a water- and oil-repellent agent for textile.

### BACKGROUND OF THE INVENTION

U.S. Pat. No. 5,324,763 (1994), U.S. Pat. No. 5,344,903 (1994), U.S. Pat. No. 6,121,372 (2000), U.S. Pat. No. 6,177,531 (2001), European Patents 0898011 (1999), 0902073 (1999), 1016700 (2000), 1088873 (2001), and Japan Patent 06240239 (1999) have disclosed that a water- and oil-repellent agent of aqueous dispersion type can be obtained by polymerizing a CH₂═C(R¹)CO₂CH₂CH₂R^{f} mixture (wherein R¹ is hydrogen or methyl, and R^{f} is a perfluoroalkyl), vinylidene chloride, an acrylate monomer, and an ionic surfactant in water/organic dissolution agent. In the methods disclosed in U.S. Pat. No. 6,121,372 (2000) and European Patents 1016700 (2000), and 1088873 (2001), the reaction process is carried out in a high pressure homogenizer at 200˜600 atm to produce an emulsified water- and oil-repellent agent with a small particle size. U.S. Pat. No. 5,344,903 (1994) has disclosed a method for preparing a water- and oil-repellent agent of aqueous dispersion type, which comprises emulsifying perfluoroalkyl(meth)acrylate(mixture)/stearyl(meth)acrylate/2-hydroxyethyl methacrylate (9-ethylene oxide) adduct/N-methylol(meth)acrylamide/2-hydroxyethyl (meth)acrylate/dodecylmercaptan/nonionic surfactant/water, followed by polymerizing the resulting mixture with vinylidene chloride/organic dissolution agent/free radical initiator.

### SUMMARY OF THE INVENTION

The present invention discloses a method for preparing a water- and oil-repellent agent, which comprises conducting a polymerization in a mixture comprising perfluoroalkyl(meth)acrylate (mixture)/alkyl(meth)acrylate/hydroxyalkyl(meth)acrylate/polyoxyalkylene glycol mono(meth)acrylate/non-ionic surfactant/ionic surfactant/vinyl monomer/chain transfer agent/water/organic dissolution agent/free radical initiator. The process of the present invention does not require a high pressure homogenizer or a special emulsifying equipment, and requires only a mechanical stirring at 250˜400 rpm to produce a water- and oil-repellent agent as an emulsion containing copolymer particles smaller than 200 nm, which is readily to be diluted as desired to form an aqueous dispersion, i.e. a diluted water- and oil-repellent agent. During the polymerization, a sugar alcohol type polymer protector (e.g. sorbitol) can be optionally added.

After numerous experiments, a special formula is developed by the present inventors, which allows the preparation of a water- and oil-repellent agent of an aqueous dispersion type containing a copolymer having a particle size less than 200 nm (about 100 nm) by a single step under stirring.

### DETAILED DESCRIPTION OF THE INVENTION

The present invention provides a method for preparing a water- and oil-repellent agent, which comprises conducting a copolymerization reaction of the following monomers i) to v) in a mixed solution of water and an organic dissolution agent by using a free radical initiator and in the presence of an ionic surfactant, a non-ionic surfactant, and a chain transfer agent:
i) a perfluoroalkyl(meth)acrylate mixture with the following formula:
   R^{f}-Q-OCOCR¹═CH₂;
   wherein R¹is H or methyl, R^{f} is a perfluoro C₂₋₂₀ alkyl, and Q is —(CH₂)_{p+q}—, —(CH₂)ₚCONH(CH₂)_{q}—, (CH₂)ₚOCONH(CH₂)_{q}—, —(CH₂)ₚSO₂NR²(CH₂)_{q}—, —(CH₂)ₚNHCONH(CH₂)_{q}— or —(CH₂)ₚCH(OH)-(CH₂)_{q}—, wherein R² is H or C1-C4 alkyl, p and q separately represent an integer of more than 0, and p+q=1˜22;
ii) C2-C20 alkyl (meth)acrylate;
iii) hydroxy C2-C6 alkyl (meth)acrylate;
iv) poly(oxy C2-C4 alkylene glycol)mono(meth)acrylate having a number average molecular weight of 100-800;
v) C2-C4 alkene, fluoro- or chloro-containing C2-C4 alkene, or butadiene;
wherein the monomer ii) is of 10-70 wt %, the monomer iii) is of 0.5-7 wt %, the monomer iv) is of 0.1-40 wt %, the monomer v) is of 10-50 wt %, the free radical initiator is of 0.1-2 wt %, the water is of 100-400 wt %, the organic dissolution agent is of 40-200 wt %, the ionic surfactant is of 2-8 wt %, the non-ionic surfactant is of 8-30 wt %, and the chain transfer agent is of 0.1-2 wt %, based on the weight of the monomer i).

Preferably, the copolymerization reaction is conducted at 25-100° C.

Preferably, said perfluoroalkyl(meth)acrylate mixture i) has the following formula: CH₂═C(R¹)CO₂CH₂CH₂CₙF₂ₙ₊₁ wherein R¹ is H or methyl, and n represents integers selected from the group consisting of 6, 8, 10, 12, 14 and 16.

Preferably, said C2-C20 alkyl (meth)acrylate ii) is stearyl (meth)acrylate, and the monomer ii) is of 20-40 wt %, based on the weight of the monomer i).

Preferably, said hydroxy C2-C6 alkyl (meth)acrylate iii) is 2-hydroxyethyl(meth)acrylate, and the monomer iii) is of 1.5-5 wt %, based on the weight of the monomer i).

Preferably, said poly(oxy C2-C4 alkylene glycol)mono(meth)acrylate iv) is poly(oxyethylene glycol)mono(meth)acrylate having a number average molecular weight of about 400, and the monomer iv) is of 1.5-5 wt %, based on the weight of the monomer i).

Preferably, said monomer v) is vinylidene chloride, and the monomer v) is of 20-40 wt %, based on the weight of the monomer i).

Preferably, a monomer vi) is added copolymerized with said monomers i) to v), wherein said monomer vi) is hydroxy C2-C6 alkyl (meth)acrylamide and the monomer vi) is of 0.5-7 wt %, based on the weight of the monomer i). More preferably, said monomer vi) is N-methylolacrylamide and the monomer vi) is of 1.5-5 wt %, based on the weight of the monomer i).

Preferably, said free radical initiator is an organic peroxide or an azo compound. More preferably, said free radical initiator is 2,2′-azobis(2-amidinopropane)dihydrochloride.

Preferably, said organic dissolution agent is a ketone of the following formula: R³COR⁴, wherein R³ and R⁴ independently are C₁₋₄ alkyl. More preferably, said organic dissolution agent is acetone.

Preferably, said organic dissolution agent is an alkylene glycol monomethyl ether of the following formula: HO—(CₘH₂ₘO)ᵣ—CH₃, wherein m=2˜4 and r=1˜3. More preferably, said organic dissolution agent is dipropylene glycol monomethyl ether.

Preferably, said ionic surfactant is a C12-C26 alkyltrimethylammonium halide, wherein said halide is Cl, Br or I. More preferably, said ionic surfactant is trimethyl stearyl ammonium chloride.

Preferably, said non-ionic surfactant is an alkylphenylene polyoxyethylene glycol, a polyoxyethylene glycol monofattyacid ester, or a mixture of them, wherein said alkylphenylene polyoxyethylene glycol has the following formula: R⁵Ph(OCH₂CH₂)ₜ—OH, wherein R⁵is an C6-C20 alkyl, Ph is phenylene, and t=3˜20; and said polyoxyethylene glycol monofattyacid ester has the following formula: R⁶CO(OCH₂CH₂)ₜ—OH, wherein R⁶ is a C2-C26 alkyl, and t is defined as above. For examples, said non-ionic surfactant is nonylphenylene polyoxyethylene glycol having a number average molecular weight of about 880 or poly(oxyethylene glycol)monolaurate having a number average molecular weight of about 375.

Preferably, said chain transfer agent is 1-dodecanthiol.

Preferably, said copolymerization reaction is conducted under agitation, and the copolymer obtained by said copolymerization reaction is in the form of particles with a particle size less than 200 nm. More preferably, said agitation is a mechanical agitation at 250 to 400 rpm, and the copolymer obtained by said copolymerization reaction is in the form of particles with an average particle size of about 100 nm.

A water- and oil-repellent agent of an aqueous dispersion type prepared according to the present invention contains a solid content of 1˜50 wt % and can be arbitrarily diluted with water depending on the application thereof.

A water- and oil-repellent agent of an aqueous dispersion type of the present invention can be applied on textile, fiber products, metal, glass, resin, paper, wood, leather, wool, asbestos, bricks, cement, ceramics, and metal oxides, preferably be applied on textile and fiber products, e.g. natural fiber, synthetic fiber, or mixed fiber.

The present invention can be further elaborated by the following examples which are for illustrative only and not for limiting the scope of the present invention.

In the following examples, a dynamic light scattering apparatus or an electron microscope was used for measuring the average particle size of the copolymer.

### EXAMPLE 1

32 g of fluoroacrylates, CH₂═C(CH₃)CO₂CH₂CH₂CₙF₂₊₁, wherein n=6, 8, 10, 12, 14, and 16; 9 g of stearyl methacrylate; 4 g of poly(oxyethylene glycol) monolaurate (Mn about 375); 1 g of poly(oxyethylene glycol)monoacrylate (Mn about 400); 0.5 g of N-methylolacrylamide; 0.5 g of 2-hydroxyethyl methacrylate; 0.25 g of 1-dodecanthiol; 9 g of vinylene chloride; 1.2 g of trimethyl stearyl ammonium chloride; and 70 g of water were added into a 500 ml round bottom flask. The three openings of the round bottom flask were separately connected to a condenser (cooling temperature of −20° C.), a mechanical stirrer, and a temperature controller. Upon completion of the installation, nitrogen was introduced to purge the air inside the flask. Next, 25 g of acetone and 0.2 g of a free radical initiator 2,2′-azobis(2-amidinopropane)dihydrochloride were added into the flask. Reactions were allowed to carry out in the flask under a mechanical stirring at 400 rpm and at 60° C. for 18 hours. 146 g of a white emulsion was obtained wherein the solid content is 30.5 wt %. Said solid contained 12.0 wt % of fluorine and 1.96 wt % of chlorine, and had an average particle size of 95 nm.

### EXAMPLE 2

The procedures in Example 1 were repeated except that 1.7 g instead of 1.2 g of trimethyl stearyl ammonium chloride was added and the speed of the mechanical stirring was changed from 250 rpm to 400 rpm.

136 g of a white emulsion having a solid content of 34.3% was obtained. Said solid contained 13.6 wt % of fluorine and 2.54 wt % of chlorine, and had an average particle size of 133 nm.

### EXAMPLE 3

In addition to 3.0 g of sorbitol being added together with other monomers, the steps of Example 2 were repeated.

145.5 g of a white emulsion having a solid content of 35.5% was obtained. Said solid contained 13.3 wt % of fluorine and 2.68 wt % of chlorine, and had an average particle size of 107 nm.

Treatment of Fabric:

A water- and oil-repellent agent was diluted with water to a desired concentration. A nylon fabric and a polyethylene terephthalate (PET) fabric were immersed in said diluted agent until fully wet. Next, the fabrics were pressed through a pair of rubber rolls at 3 Kg/cm². Next, the nylon fabric was oven dried at 170° C. for 50 seconds and the PET fabric was oven dried at 140° C. for 70 seconds.

Evaluation of Water Repellency:

The water repellency test was performed according to JIS L1092 and was classified according to the following table, wherein the “+” or “−” signs added beside the degree of water repellency separately indicate that the water repellency is “slightly better” or “slightly worse” than the degree stated.

| Degree of water repellency | Status |
|---|---|
| 100 | No adhesion or wetting on surface |
| 90 | Slight adhesion or wetting on surface |
| 80 | Partial wetting on surface |
| 70 | Wetting on surface |
| 50 | Wetting on whole surface |
| 0 | Complete wetting on front and back surfaces |

Evaluation of Oil Repellency:

The evaluation of oil repellency was performed according to AATCC-TM118. The degrees of oil repellency were shown in the following table, wherein the “+” or “−” signs added beside the degree of oil repellency separately indicate that the oil repellency is “slightly better” or “slightly worse” than the degree stated.

| Degree of oil | | Surface tension of test |
|---|---|---|
| repellency | Test liquid | liquid (dyne/cm at 25° C.) |
| 8 | n-heptane | 20.0 |
| 7 | n-octane | 21.8 |
| 6 | n-decane | 23.5 |
| 5 | n-dodecane | 25.0 |
| 4 | n-tetradecane | 26.7 |
| 3 | n-hexadecane | 27.3 |
| 2 | 65 parts of nujol/35 parts of | 29.6 |
| | n-hexadecane | |
| 1 | nujol | 31.2 |

Degree of water repellency and oil repellency for Examples 1 to 3

| | | | |
|---|---|---|---|
| Concentration | | | |
| of diluted agent | Example 1 | Example 2 | Example 3 |

Nylon

| | | | | |
|---|---|---|---|---|
| 0.6% | Water | 90+ | 100 | 100 |
| | repellency | | | |

PET

| | | | | |
|---|---|---|---|---|
| 0.1% | Water | 100 | 80+ | 100 |
| | repellency | | | |
| 0.2% | Oil | 3 | 4 | 5 |
| | repellency | | | |

### EXAMPLES 4 TO 10

0.2 g of initiator 2,2′-azobis(2-amidinopropane)dihydrochloride, 70 g of water, 0.25 g of 1-dodecylmercaptan were used. The amounts of other reactants were listed in Table 1. The copolymerization reaction was carried out according to the operation conditions in Example 1. The solid content and the average particle size of the soild of the emulsions prepared, and the test results of the water repellency of the diluted agents (being diluted to 0.6% solid content) on nylon and PET fabrics are also listed in Table 1.

TABLE 1

| | Ex. 4 | Ex. 5 | Ex. 6 | Ex. 7 | Ex. 8 | Ex. 9 | Ex. 10 |
|---|---|---|---|---|---|---|---|
| PFA* | 32 | 32 | 28 | 32 | 32 | 32 | 32 |
| STA* | 9 | 9 | 12 | 10 | 9 | 9 | 9 |
| PEGML* | 4 | 4 | — | — | 6 | 6 | 6 |
| PEGA* | 1 | 1 | — | — | 1 | 1 | 1 |
| MLAA* | 0.5 | 0.5 | — | 0.5 | 1.5 | 1.5 | 1.5 |
| HEM* | 0.5 | 0.5 | 1 | 1 | 1.5 | 1.5 | 1.5 |
| VCL* | 9 | 9 | — | — | 9 | 9 | 7 |
| TMSC* | 1 | 1 | 1.2 | 1.2 | 1.2 | 1 | 1 |
| Acetone | 25 | 25 | 20 | 20 | 20 | — | 35 |
| DPGME* | — | — | — | 20 | 20 | 60 | 20 |
| NPPG* | — | — | — | 3.2 | 3.2 | — | — |
| Solid content | 35.3% | 33.5% | 28.3% | 29.3% | 31.3% | 32.8% | 29.9% |
| Average particle size (nm) | 112 | 107 | 96 | 102 | 165 | 113 | 164 |
| Water repellency on Nylon | 90 | 90 | 70+ | 80+ | 90 | 70+ | 90− |
| Water repellency on PET | 90 | 100 | 80 | 80− | 100 | 80 | 100 |

*PFA: fluoroacrylates, CH₂═C(CH₃)CO₂CH₂CH₂CₙF₂ₙ₊₁, wherein n = 6, 8, 10, 12, 14, and16)
STA: Stearyl methacrylate
PEGML: Poly(oxyethylene glycol) monolaurate (Mn˜375)
PEGA: Poly(oxyethylene glycol) monoacrylate (Mn˜400)
MLAA: N-methylolacrylamide
HEM: 2-Hydroxyethyl methacrylate
VCL: Vinylene chloride
TMSC: Trimethyl stearylammonium chloride
DPGME: dipropylene glycol monomethyl ether
NPPG: nonylphenylene polyoxyethylene glycol (Mn˜880)

Table 1 show that the diluted agents of Example 7 and 8 have a poorer water repellency due to the absence of PEGA and VCL, and the diluted agent of Example 9 has a poorer water repellency due to the absence of the dissolution agent, acetone.

1. A method for preparing a water- and oil-repellent agent, which comprises conducting a copolymerization reaction of the following monomers i) to v) in a mixed solution of water and an organic dissolution agent by using a free radical initiator and in the presence of an ionic surfactant, a non-ionic surfactant, and a chain transfer agent:
i) a perfluoroalkyl(meth)acrylate mixture with the following formula:
R^{f}-Q-OCOCR¹═CH₂;
wherein R¹ is H or methyl, R^{f} is a perfluoro C₂₋₂₀ alkyl, and Q is —(CH₂)_{p+q}—, —(CH₂)ₚCONH(CH₂)_{q}—, —(CH₂)ₚOCONH(CH₂)_{q}—, —(CH₂)ₚSO₂NR²(CH₂)_{q}—, —(CH₂)ₚNHCONH(CH₂)_{q}— or —(CH₂)ₚCH(OH)—(CH₂)_{q}—, wherein R² is H or C1-C4 alkyl, p and q separately represent an integer of more than 0, and p+q=1-22;
ii) C2-C20 alkyl (meth)acrylate;
iii) hydroxy C2-C6 alkyl (meth)acrylate;
iv) poly(oxy C2-C4 alkylene glycol) mono(meth)acrylate having a number average molecular weight of 100-800;
v) C2-C4 alkene, fluoro- or chloro-containing C2-C4 alkene, or butadiene;
wherein the monomer ii) is of 10-70 wt %, the monomer iii) is of 0.5-7 wt %, the monomer iv) is of 0.1-40 wt %, the monomer v) is of 10-50 wt %, the free radical initiator is of 0.1-2 wt %, the water is of 100-400 wt %, the organic dissolution agent is of 40-200 wt %, the ionic surfactant is of 2-8 wt %, the non-ionic surfactant is of 8-30 wt %, and the chain transfer agent is of 0.1-2 wt %, based on the weight of the monomer i).

2. The method as claimed in claim 1, wherein the copolymerization reaction is conducted at 25˜100° C.

3. The method as claimed in claim 1, wherein said perfluoroalkyl (meth)acrylate mixture i) has the following formula:
CH₂═C(R¹)CO₂CH₂CH₂CₙF₂ₙ₊₁
wherein R¹ is H or methyl, and n represents integers selected from the group consisting of 6, 8, 10, 12, 14 and 16.

4. The method as claimed in claim 1, wherein said C2-C20 alkyl(meth)acrylate ii) is stearyl(meth)acrylate, and the monomer ii) is of 20-40 wt %, based on the weight of the monomer i).

5. The method as claimed in claim 1, wherein said hydroxy C2-C6 alkyl(meth)acrylate iii) is 2-hydroxyethyl(meth)acrylate, and the monomer iii) is of 1.5-5 wt %, based on the weight of the monomer i).

6. The method as claimed in claim 1, wherein said poly(oxy C2-C4 alkylene glycol)mono(meth)acrylate iv) is poly(oxyethylene glycol)mono(meth)acrylate having a number average molecular weight of about 400, and the monomer iv) is of 1.5-5 wt %, based on the weight of the monomer i).

7. The method as claimed in claim 1, wherein said monomer v) is vinylidene chloride, and the monomer v) is of 20-40 wt %, based on the weight of the monomer i).

8. The method as claimed in claim 1, wherein a monomer vi) is added copolymerized with said monomers i) to v), wherein said monomer vi) is hydroxy C2-C6 alkyl(meth)acrylamide and the monomer vi) is of 0.5-7 wt %, based on the weight of the monomer i).

9. The method as claimed in claim 8, wherein said monomer vi) is N-methylolacrylamide and the monomer vi) is of 1.5-5 wt %, based on the weight of the monomer i).

10. The method as claimed in claim 1, wherein said free radical initiator is an organic peroxide or an azo compound.

11. The method as claimed in claim 10, wherein said free radical initiator is 2,2′-azobis(2-amidinopropane)dihydrochloride.

12. The method as claimed in claim 1, wherein said organic dissolution agent is a ketone of the following formula: R³COR⁴, wherein R³ and R⁴ independently are C_{1˜4} alkyl.

13. The method as claimed in claim 12, wherein said organic dissolution agent is acetone.

14. The method as claimed in claim 1, wherein said organic dissolution agent is an alkylene glycol monomethyl ether of the following formula: HO—(CₘH₂ₘO)ᵣ—CH₃, wherein m=2˜4 and r=1˜3.

15. The method as claimed in claim 14, wherein said organic dissolution agent is dipropylene glycol monomethyl ether.

16. The method as claimed in claim 1, wherein said ionic surfactant is a C12-C26 alkyltrimethylammonium halide, wherein said halide is Cl, Br or I.

17. The method as claimed in claim 16, wherein said ionic surfactant is trimethyl stearyl ammonium chloride.

18. The method as claimed in claim 1, wherein said non-ionic surfactant is an alkylphenylene polyoxyethylene glycol, a polyoxyethylene glycol monofattyacid ester, or a mixture of them, wherein said alkylphenylene polyoxyethylene glycol has the following formula: R⁵Ph(OCH₂CH₂)ₜ—OH, wherein R⁵ is an C6-C20 alkyl, Ph is phenylene, and t=3˜20; and said polyoxyethylene glycol monofattyacid ester has the following formula: R⁶CO(OCH₂CH₂)ₜ—OH, wherein R⁶ is a C2-C26 alkyl, and t is defined as above.

19. The method as claimed in claim 18, wherein said non-ionic surfactant is nonylphenylene polyoxyethylene glycol having a number average molecular weight of about 880.

20. The method as claimed in claim 18, wherein said non-ionic surfactant is poly(oxyethylene glycol)monolaurate having a number average molecular weight of about 375.

21. The method as claimed in claim 1, wherein said chain transfer agent is 1-dodecanthiol.

22. The method as claimed in claim 1, wherein said copolymerization reaction is conducted under agitation, and the copolymer obtained by said copolymerization reaction is in the form of particles with a particle size less than 200 nm.

23. The method as claimed in claim 22, wherein said agitation is a mechanical agitation at 250 to 400 rpm, and the copolymer obtained by said copolymerization reaction is in the form of particles with an average particle size of about 100 nm.

24. A method for preparing a water- and oil-repellent agent, which comprises conducting a copolymerization reaction of the following monomers i) to vi) in a mixed solution of water and an organic dissolution agent by using a free radical initiator and in the presence of an ionic surfactant, a non-ionic surfactant, and a chain transfer agent:
i) a perfluoroalkyl(meth)acrylate mixture with the following formula:
CH₂═C(R¹)CO₂CH₂CH₂CₙF₂ₙ₊₁
wherein R¹ is H or methyl, and n represents integers selected from the group consisting of 6, 8, 10, 12, 14 and 16.
ii) stearyl(meth)acrylate;
iii) 2-hydroxyethyl(meth)acrylate;
iv) poly(oxyethylene glycol)mono(meth)acrylate having a number average molecular weight of about 400;
v) vinylidene chloride;
vi) N-methylolacrylamide;
wherein the monomer ii) is of 20-40 wt %, the monomer iii) is of 1.5-5 wt %, the monomer iv) is of 1.5-5 wt %, the monomer v) is of 20-40 wt %, the monomer vi) is of 1.5-5 wt %, the free radical initiator is of 0.1-2 wt %, the water is of 100-400 wt %, the organic dissolution agent is of 40-200 wt %, the ionic surfactant is of 2-8 wt %, the non-ionic surfactant is of 8-30 wt %, and the chain transfer agent is of 0.1-2 wt %, based on the weight of the monomer i),
wherein said organic dissolution agent is a ketone of the following formula: R³COR⁴, wherein R³ and R⁴ independently are C_{1˜4} alkyl; or an alkylene glycol monomethyl ether of the following formula:
HO—(CₘH₂ₘO)ᵣ—CH₃, wherein m=2˜4 and r=1˜3;
said ionic surfactant is a C12-C26 alkyltrimethylammonium halide, wherein said halide is Cl, Br or I; and
said non-ionic surfactant is an alkylphenylene polyoxyethylene glycol, a polyoxyethylene glycol monofattyacid ester, or a mixture of them, wherein said alkylphenylene polyoxyethylene glycol has the following formula: R⁵Ph(OCH₂CH₂)ₜ—OH, wherein R⁵ is an C6-C20 alkyl, Ph is phenylene, and t=3˜20; and said polyoxyethylene glycol monofattyacid ester has the following formula: R⁶CO(OCH₂CH₂)ₜ—OH, wherein R⁶ is a C2-C26 alkyl, and t is defined as above.

25. The method as claimed in claim 24, wherein said copolymerization reaction is conducted at a temperature of 25-100° C.

26. The method as claimed in claim 24, wherein said free radical initiator is an organic peroxide or an azo compound.

27. The method as claimed in claim 26, wherein said free radical initiator is 2,2′-azobis(2-amidinopropane)dihydrochloride.

28. The method as claimed in claim 24, wherein said organic dissolution agent is acetone.

29. The method as claimed in claim 24, wherein said organic dissolution agent is dipropylene glycol monomethyl ether.

30. The method as claimed in claim 24, wherein said ionic surfactant is trimethyl stearylammonium chloride.

31. The method as claimed in claim 24, wherein said non-ionic surfactant is nonylphenylene polyoxyethylene glycol having a number average molecular weight of about 880.

32. The method as claimed in claim 24, wherein said non-ionic surfactant is poly(oxyethylene glycol)monolaurate having a number average molecular weight of about 375.

33. The method as claimed in claim 24, wherein said chain transfer agent is 1-dodecanthiol.

34. The method as claimed in claim 24, wherein said copolymerization reaction is conducted under agitation, and the copolymer obtained by said copolymerization reaction is in the form of particles with a particle size less than 200 nm.

35. The method as claimed in claim 34, wherein said agitation is a mechanical agitation at 250 to 400 rpm, and the copolymer obtained by said copolymerization reaction is in the form of particles with an average particle size of about 100 nm.
